(19) United States
(12) Patent Application Publication
(10) Pub. No.: US 2018/0133717 A1
(43) Pub. Date: May 17, 2018

(54) Paper Shredder

(71) Applicant: ChangZhou Dowell Office Equipment CO., LTD., Changzhou (CN)

(72) Inventor: Min YIN, Changzhou (CN)

(21) Appl. No.: 15/354,242

(22) Filed: Nov. 17, 2016

(51) Int. Cl. B02C 18/00; B02C 25/00; F16P 3/14

(52) U.S. Cl. CPC B02C 18/0007; B02C 2018/168; F16P 3/147; B02C 25/00

(57) ABSTRACT

A paper shredder, comprising a housing provided with a paper inlet, a motor arranged in the housing, a control circuit module for controlling the motor to operate, at least one inductive electric conductor and a human inductive signal processing output module, wherein the inductive electric conductor is arranged at the inner wall of the housing near the paper inlet; the inductive electric conductor and the inner wall of the housing are in isolating contact or have a gap; the inductive electric conductor is electrically connected with the human inductive signal processing output module; and the human inductive signal processing output module is electrically connected with the control circuit module. The paper shredder has the advantages of simple structure, low cost, high safety and reliability, etc.

### TECHNICAL FIELD

The present invention relates to a control device specially suitable for fragmentation or shredding, and particularly relates to a paper shredder, in particular to a paper shredder having a safety protection function.

### BACKGROUND ART

With the progress of the society and the development of the technology, companies or individuals pay more and more attention to keep technical or business secrets. Especially, they do not dare to arbitrarily discard waste paper with technical or business secrets, but process the waste paper into fragments through a paper shredder.

The paper shredder in the prior art has caused many accidents, mainly the injury to human hands. For example, if the paper shredder is applied to a family, a child likes to insert a finger into a paper inlet of the paper shredder for the lack of safety consciousness, and if the paper shredder is in operation, an accident of an injury to the finger of the child may be caused. Even in an office application occasion, the accident that the human hand enters the paper inlet of the paper shredder by mistake is occasionally generated.

Therefore, the industry pays more and more attention to the enhancement of the safety of the paper shredder. However, demands for the paper shredder are increased, but the companies for making the paper shredder are also gradually increased and the competition becomes more and more fierce; as the price of raw material is increased, the cost of the paper shredder is also increased. At present, an important problem for all companies of the paper shredder is how to reduce the cost of the paper shredder and enhance the safety of the paper shredder under the condition of ensuring the quality of the paper shredder.

In the prior art, there is a paper shredder for avoiding injuring the human hand. The paper shredder needs to install two opposite galvanized metal sheets or conductive plastic sheets along the paper inlet on the plastic housing of the paper shredder, or a metal housing is directly adopted, or a layer of metal coating is electroplated on the plastic housing; and the galvanized metal sheets, the conductive plastic sheets, the metal housing or the metal coating is connected with an internal circuit. When the paper shredder is in operation, if the human hand touches the galvanized metal sheets, the conductive plastic sheets, the metal housing or the metal coating, the internal circuit controls a motor to immediately stop operating, thereby avoiding injuring the human hand, but when the human hand does not touch the galvanized metal sheets, the conductive plastic sheets, the metal housing or the metal coating, the internal circuit controls the motor to continue to operate. The paper shredder in the prior art has the following defects:

I. If the human hand does not touch the galvanized metal sheets, the conductive plastic sheets, the metal housing or the metal coating, but the human hand (for example, a small hand of the child) still stretches into the paper inlet of the paper shredder and touches a paper shredding blade group, then the internal circuit also controls the motor to operate and the paper shredding blade group still injures the human hand;

II. When the paper shredder is in operation, the galvanized metal sheets, the conductive plastic sheets, the metal housing or the metal coating has electricity; although the voltage and the current are small, the human hand is not safe when in touch, and is especially not safe for the children; although the paper shredder does not involve the danger of life, the psychology of the children is adversely affected if the children are shocked;

III. The cost of the paper shredder is relatively high.

### SUMMARY OF THE INVENTION

The technical problem the invention aims to settle, lies in that to avoid the above-mentioned deficiencies of prior art and to provide a paper shredder, having the advantages of simple structure, low cost, high safety and reliability, etc.

The technical solution adopted in the invention to resolve the said problem is as follows:

a paper shredder is provided, comprising a housing provided with a paper inlet, a motor arranged in the housing, and a control circuit module for controlling the motor to operate, and further comprising at least one inductive electric conductor and a human inductive signal processing output module, wherein the inductive electric conductor is arranged at the inner wall of the housing near the paper inlet; the inductive electric conductor and the inner wall of the housing are in isolating contact or have a gap; the inductive electric conductor is electrically connected with the human inductive signal processing output module; and the human inductive signal processing output module is electrically connected with the control circuit module. The human inductive signal processing output module is triggered to operate after inducing a human hand signal through the inductive electric conductor, and enables the motor to stop operating after outputting the signal to the control circuit module.

when the paper shredder is in operation, when a human hand approaches or contacts the housing at the paper inlet, the inductive electric conductor at the paper inlet of the housing immediately induces the human hand signal and transmits the human hand signal to the human inductive signal processing output module; the human inductive signal processing output module is operated and outputs the signal to the control circuit module; the motor is immediately de-energized to stop operating after the control circuit module receives the signal of the human inductive signal processing output module; when the human hand is away from the housing at the paper inlet, the inductive electric conductor at the paper inlet of the housing does not induce the human hand signal; the human inductive signal processing output module is not operated; and the control circuit module and the motor maintain previous operating states when the paper shredder is in operation.

The inductive electric conductor is a metal foil, iron wire, copper wire or enameled wire.

The number of the inductive electric conductors is two; the inductive electric conductors are respectively arranged at the inner wall of the housing near both sides of the paper inlet; and the length of each inductive electric conductor is equal to or slightly less than the length of the paper inlet.

The human inductive signal processing output module comprises a human inductive integrated circuit U3, a triode T3 and the same number of resistors as that of the inductive electric conductors. Each inductive electric conductor is respectively electrically connected between each input pin of the human inductive integrated circuit U3 and ground; each corresponding resistor is respectively electrically connected between each corresponding output pin of the human inductive integrated circuit U3 and a base of the triode T3; a power pin VDD of the human inductive integrated circuit U3 is externally connected with a positive power supply; a collector of the triode T3 is grounded; an emitter of the triode T3, as an output end of the human inductive signal processing output module, is electrically connected with the control circuit module; after any input pin of the human inductive integrated circuit U3, which is connected with the inductive electric conductors, induces the human hand signal through the inductive electric conductors, the human inductive integrated circuit U3 is triggered to operate; a resistor corresponding to the inductive electric conductors outputs a voltage signal to activate the triode T3; and the motor is made to stop operating after the emitter of the triode T3 outputs the signal to the control circuit module.

For example, the human inductive signal processing output module comprises a human inductive integrated circuit U3, a triode T3 and two resistors. Two inductive electric conductors are respectively electrically connected between each input pin of the human inductive integrated circuit U3 and ground; two resistors are respectively electrically connected between each corresponding output pin of the human inductive integrated circuit U3 and a base of the triode T3; a power pin VDD of the human inductive integrated circuit U3 is externally connected with a positive power supply; a collector of the triode T3 is grounded; an emitter of the triode T3, as an output end of the human inductive signal processing output module (800), is electrically connected with the control circuit module;

the triode T3 is a PNP type triode and has a model of 9012.

Compared with the prior art, the paper shredder of the present invention has the following beneficial effects:

In the paper shredder of the present invention, at least one inductive electric conductor is arranged at the inner wall of the housing near the paper inlet, and a human inductive signal processing output module electrically connected with the inductive electric conductor is arranged, so as to transmit the human hand signal in time to the control circuit module for controlling the motor to operate after the human hand approaches or contacts the housing at the paper inlet and immediately de-energize the motor to stop operating, thereby preventing an accident of accidentally injuring the human hand from occurring. In the process of safe shutdown, even if the human hand contacts the housing at the paper inlet, the human hand still does not contact the inductive electric conductor. The paper shredder of the present invention has the advantages of simple structure, low cost, high safety and reliability, etc.

### BRIEF DESCRIPTION OF DRAWINGS

FIG. 1 is a top schematic diagram of orthographic projection of a paper shredder of the present invention;

FIG. 2 is an enlarged sectional schematic diagram of A-A shown in FIG. 1; only a positional relationship between an inductive electric conductor 900 and a paper inlet 110 of a housing 100 is drawn in the sectional diagram, and other components are not drawn;

FIG. 3 is a schematic diagram of a circuit principle of the paper shredder;

FIG. 4 is a first schematic diagram of circuit wiring for inductive electric conductors 900 and a human inductive signal processing output module 800 of the paper shredder; two inductive electric conductors 900 are arranged in the circuit diagram;

FIG. 5 is a second schematic diagram of circuit wiring for an inductive electric conductor 900 and a human inductive signal processing output module 800 of the paper shredder; one inductive electric conductor 900 is arranged in the circuit diagram;

FIG. 6 is a third schematic diagram of circuit wiring for inductive electric conductors 900 and a human inductive signal processing output module 800 of the paper shredder; three inductive electric conductors 900 are arranged in the circuit diagram;

FIG. 7 is a fourth schematic diagram of circuit wiring for inductive electric conductors 900 and a human inductive signal processing output module 800 of the paper shredder; two inductive electric conductors 900 are arranged in the circuit diagram;

FIG. 8 is a fifth schematic diagram of circuit wiring for an inductive electric conductor 900 and a human inductive signal processing output module 800 of the paper shredder; one inductive electric conductor 900 is arranged in the circuit diagram; and

FIG. 9 is a schematic diagram of a specific circuit of a control circuit module 300 of the paper shredder.

### DETAILED DESCRIPTION OF THE PREFERRED EMBODIMENT

Now, further detailed instructions will be made on the invention combining each attached drawing.

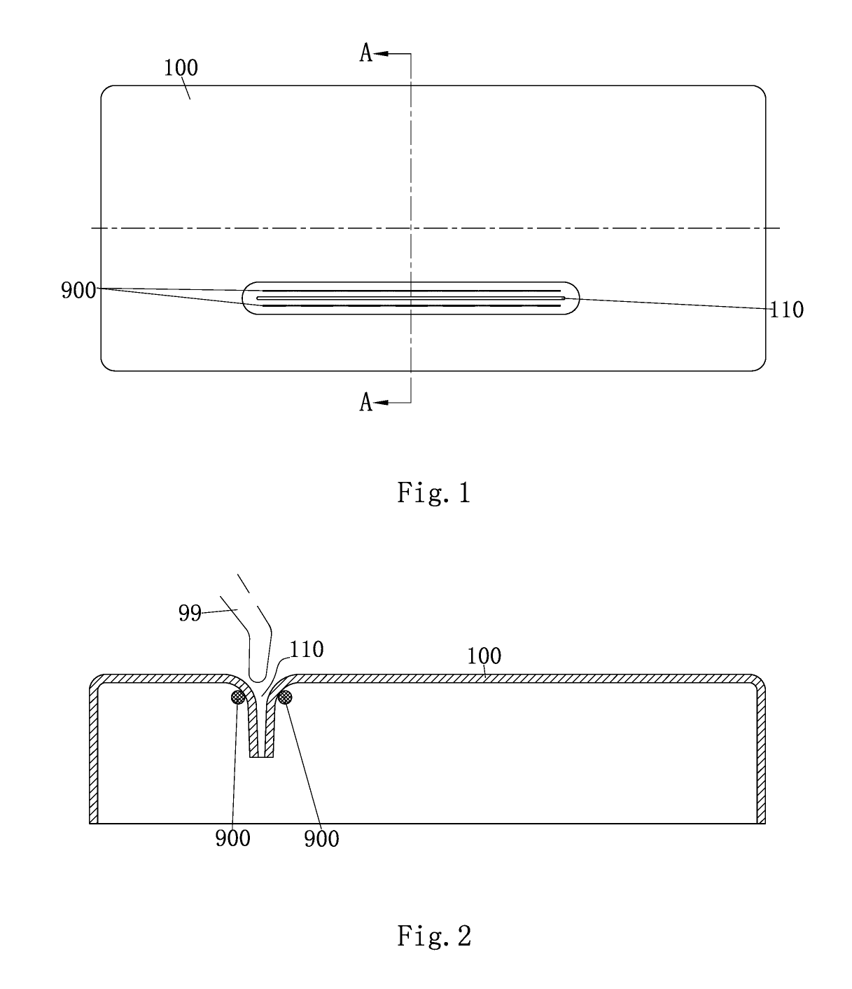

As shown in FIG. 1 to FIG. 9, a paper shredder comprises a housing provided 100 with a paper inlet 110, a motor 200 arranged in the housing 100, and a control circuit module 300 for controlling the motor 200 to operate, and further comprising at least one inductive electric conductor 900 and a human inductive signal processing output module 800, wherein the inductive electric conductor 900 is arranged at the inner wall of the housing 100 near the paper inlet 110; the inductive electric conductor 900 and the inner wall of the housing 100 are in isolating contact or have a gap; if the gap exists, the gap between the inductive electric conductor 900 and the inner wall of the housing 100 is generally less than or equal to 5 mm; if the housing 100 is made of engineering plastics, the inductive electric conductor 900 can be directly selected from a metal foil, iron wire, copper wire or enameled wire, and is arranged at the inner wall of the housing 100 near or in contact with the paper inlet 110; if the housing 100 is made of stainless steel or other metal materials, the inductive electric conductor 900 can be directly selected from an inductive electric conductor having an insulation layer outside such as enameled wire and the like, and is arranged at the inner wall of the housing 100 near or in contact with the paper inlet 110, or is selected from an exposed inductive electric conductor such as metal foil, iron wire or copper wire, and is arranged at the inner wall of the housing 100 near or in contact with the paper inlet 110 after wrapped with the insulation material; the inductive electric conductor 900 is electrically connected with the human inductive signal processing output module 800; the human inductive signal processing output module 800 is electrically connected with the control circuit module 300; and the human inductive signal processing output module 800 is triggered to operate after inducing a human hand signal through the inductive electric conductor 900, and enables the motor 200 to stop operating after outputting the signal (the output signal is generally a voltage signal, including a high level or a low level) to the control circuit module 300.

As shown in FIG. 1 to FIG. 3, when the paper shredder is in operation, if a human hand approaches or contacts the housing 100 at the paper inlet 110, because the inductive electric conductor 900 and the inner wall of the housing 100 are in isolating contact or have a gap, even if the human hand contacts the housing at the paper inlet, the human hand still does not contact the inductive electric conductor; the inductive electric conductor 900 at the paper inlet 110 of the housing 100 immediately induces the human hand signal and transmits the human hand signal to the human inductive signal processing output module 800; because a human body has static electricity, when the human hand approaches or contacts the housing 100 at the paper inlet 110, the static electricity of the human body is delivered through the human hand and the inductive electric conductor 900 to the human inductive signal processing output module 800; the human inductive signal processing output module 800 is operated, and outputs the signal to the control circuit module 300; and the motor 200 is immediately de-energized to stop operating after the control circuit module 300 receives the signal of the human inductive signal processing output module 800. When the human hand is away from the housing 100 at the paper inlet 110, the inductive electric conductor 900 at the paper inlet 110 of the housing 100 does not induce the human hand signal; the human inductive signal processing output module 800 is not operated; and the control circuit module 300 and the motor 200 maintain previous operating states when the paper shredder is in operation.

The distance at which the human hand approaches the housing 100 at the paper inlet 110 is determined by customer requirements and articles processed by the paper shredder. Generally, the distance at which the human hand approaches the housing 100 at the paper inlet 110 is preferably designed to be less than or equal to 50 mm, thereby ensuring that the processed articles are successfully smashed through the paper shredder and also ensuring that the motor 200 is immediately de-energized to stop operating after the inductive electric conductor 900 immediately induces the human hand signal for the purpose of safety when the distance at which the human hand approaches the housing 100 at the paper inlet 110 is less than or equal to 50 mm.

As shown in FIG. 1 and FIG. 2, the inductive electric conductor 900 is a metal foil, iron wire, copper wire or enameled wire.

As shown in FIG. 1 and FIG. 2, the number of the inductive electric conductors 900 is two; the inductive electric conductors 900 are respectively arranged at the inner wall of the housing 100 near both sides of the paper inlet 110; and the length of each inductive electric conductor 900 is equal to or slightly less than the length of the paper inlet 110.

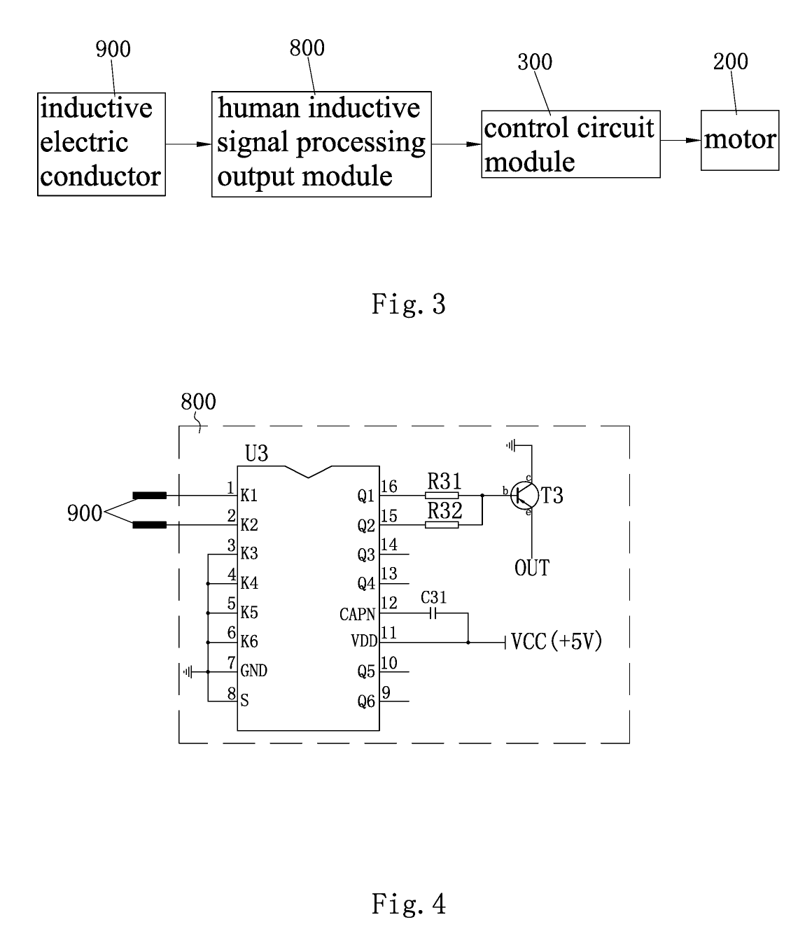

As shown in FIG. 3 to FIG. 8, the human inductive signal processing output module 800 comprises a human inductive integrated circuit U3, a triode T3 and the same number of resistors as that of the inductive electric conductors 900. Each inductive electric conductor 900 is respectively electrically connected between each input pin of the human inductive integrated circuit U3 and ground; each corresponding resistor is respectively electrically connected between each corresponding output pin of the human inductive integrated circuit U3 and a base of the triode T3; a power pin VDD of the human inductive integrated circuit U3 is externally connected with a positive power supply; a collector of the triode T3 is grounded; an emitter of the triode T3, as an output end of the human inductive signal processing output module 800, is electrically connected with the control circuit module 300; after any input pin of the human inductive integrated circuit U3, which is connected with the inductive electric conductors 900, induces the human hand signal through the inductive electric conductors 900, the human inductive integrated circuit U3 is triggered to operate; a resistor corresponding to the inductive electric conductors 900 outputs a voltage signal to activate the triode T3; and the motor 200 is made to stop operating after the emitter of the triode T3 outputs the signal to the control circuit module 300.

As shown in FIG. 4 to FIG. 8, the triode T3 is a PNP type triode and has a model of 9012.

### Embodiment 1

As shown in FIG. 1 to FIG. 4, a paper shredder comprises a housing 100 provided with a paper inlet 110, a motor 200 arranged in the housing 100, and a control circuit module 300 for controlling the motor 200 to operate, and further comprises two inductive electric conductors 900 and a human inductive signal processing output module 800, wherein two inductive electric conductors 900 are respectively arranged at the inner wall of the housing 100 near both sides of the paper inlet 110; two inductive electric conductors 900 and the inner wall of the housing 100 are in isolating contact or have a slight gap; and the length of each inductive electric conductor 900 is equal to or slightly less than the length of the paper inlet 110. The inductive electric conductor 900 is electrically connected with the human inductive signal processing output module 800; and the human inductive signal processing output module 800 is electrically connected with the control circuit module 300.

As shown in FIG. 1 to FIG. 4, the human inductive signal processing output module 800 comprises a human inductive integrated circuit U3, a triode T3 and two resistors R31 and R32; the human inductive integrated circuit U3 is also known as a capacitive touch button processing chip and has 16 pins, including 6 input pins K1, K2, K3, K4, K5 and K6 and successively corresponding 6 output pins Q1, Q2, Q3, Q4, Q5 and Q6. At least one inductive electric conductor 900, and a maximum of 6 inductive electric conductors 900 can be electrically connected. The human inductive integrated circuit U3 can be designed to induce the signal when the distance from the human hand to the housing 100 at the paper inlet 110 is not greater than 50 mm; and the triode T3 is a PNP type triode and has a model of 9012. Two inductive electric conductors 900 are selected from metal foils, wherein one inductive electric conductor 900 is electrically connected between the input pin K1 of the human inductive integrated circuit U3 and ground; the resistor R31 corresponding to the inductive electric conductor 900 is electrically connected between the output pin Q1 of the human inductive integrated circuit U3 and a base b of the triode T3; another inductive electric conductor 900 is electrically connected between the input pin K2 of the human inductive integrated circuit U3 and ground; the resistor R32 corresponding to the inductive electric conductor 900 is electrically connected between the output pin Q2 of the human inductive integrated circuit U3 and the base b of the triode T3; a power pin VDD of the human inductive integrated circuit U3 is externally connected with a positive power supply VCC; DC voltage of +5V can be adopted as the positive power supply VCC; a collector c of the triode T3 is grounded; an emitter e of the triode T3, as an output end of the human inductive signal processing output module 800, is electrically connected with the control circuit module 300; the other 4 input pins K3, K4, K5 and K6 of the human inductive integrated circuit U3 together with pin S and a ground pin GND are grounded; and the other 4 output pins Q3, Q4, Q5 and Q6 of the human inductive integrated circuit U3 are hung in the air.

As shown in FIG. 4, the human inductive signal processing output module 800 further comprises a capacitor C31 which is electrically connected between a capacitor pin CAPN of the human inductive integrated circuit U3 and the power pin VDD. The smaller the capacitance value of the capacitor C31 is, the higher the touch sensitivity is; and the larger the capacitance value of the capacitor C31 is, the lower the touch sensitivity is. However, it should be noted that due to the precision of an arithmetic unit of the human inductive integrated circuit U3, if the capacitance value of the capacitor C31 is too large, overflow may be caused; if the capacitance value of the capacitor C31 is too small, instability due to lower precision may be caused; generally, the capacitance value of the capacitor C31 is designed between 10000 pF (103) to 22000 pF (223); and for example, the capacitance value of the capacitor C31 is 15000 pF (153).

As shown in FIG. 1 to FIG. 4, when the paper shredder is in operation, if a human hand approaches or contacts the housing 100 at the paper inlet 110, as long as any inductive electric conductor 900 at the paper inlet 110 of the housing 100 immediately induces the human hand signal, the human hand signal is immediately transmitted to the input pin corresponding to the human inductive integrated circuit U3 of the human inductive signal processing output module 800; the human inductive integrated circuit U3 is triggered to come into operation, and outputs the voltage signal through the resistor R31 and/or resistor R32 corresponding to each inductive electric conductor 900 so as to activate the triode T3; the emitter of the triode T3 outputs the signal to the control circuit module 300; and the motor 200 is immediately de-energized to stop operating after the control circuit module 300 receives the signal of the triode T3. When the human hand is away from the housing 100 at the paper inlet 110, two inductive electric conductors 900 at the paper inlet 110 of the housing 100 induce no human hand signal; the human inductive integrated circuit U3 of the human inductive signal processing output module 800 is not operated; and the control circuit module 300 and the motor 200 maintain previous operating states when the paper shredder is in operation.

### Embodiment 2

As shown in FIG. 1 to FIG. 3 and FIG. 5, the paper shredder of the present embodiment is almost the same as that of embodiment 1, and the difference is that:

(1) only one inductive electric conductor 900 is arranged; the inductive electric conductor 900 is installed at the inner wall of the housing 100 near any side of the paper inlet 110; the inductive electric conductor 900 and the inner wall of the housing 100 are in isolating contact or have a slight gap; and the length of the inductive electric conductor 900 is equal to or slightly less than the length of the paper inlet 110; the inductive electric conductor 900 is electrically connected between the input pin K1 of the human inductive integrated circuit U3 and the ground;

(2) accordingly, only one resistor R31 is arranged; the resistor R31 is electrically connected between the output pin Q1 of the human inductive integrated circuit U3 and the base b of the triode T3; and

(3) the input pin K2 of the human inductive integrated circuit U3 is hung in the air, and the output pin Q2 of the human inductive integrated circuit U3 is also hung in the air.

### Embodiment 3

As shown in FIG. 1 to FIG. 3 and FIG. 6, the paper shredder of the present embodiment is almost the same as that of embodiment 1, and the difference is that:

(1) three inductive electric conductors 900 are arranged; the length of one inductive electric conductor 900 is equal to or slightly less than the length of the paper inlet 110; the inductive electric conductor 900 is arranged at the inner wall of the housing 100 near any side of the paper inlet 110; the addition of the lengths of the other two inductive electric conductors 900 is approximately equal to the length of the longer inductive electric conductor 900; the two inductive electric conductors 900 are arranged together at the inner wall of the housing 100 near the other side of the paper inlet 110; all the inductive electric conductors 900 and the inner wall of the housing 100 are in isolating contact or have a gap;

(2) accordingly, only three resistors R31, R32 and R33 are needed; see embodiment 1 for the connection method of the resistors R31 and R32; the resistor R33 is electrically connected between the output pin Q3 of the human inductive integrated circuit U3 and the base b of the triode T3; and

(3) the input pin K3 of the human inductive integrated circuit U3 is not grounded, but is grounded after passing through the third inductive electric conductor 900; and see embodiment 1 for the connection method of the first two the inductive electric conductors 900.

### Embodiment 4

As shown in FIG. 1 to FIG. 3 and FIG. 7, the paper shredder of the present embodiment is almost the same as that of embodiment 1, and the difference is that:

(1) the human inductive integrated circuit U3 is different; the human inductive integrated circuit U3 in the present embodiment is also known as a two-channel touch switch control chip which is a capacitive touch chip with two touch channels and two logic control outputs; 8 pins are arranged, including an optional input pin OSC, a sampling capacitor access pin VC, a power pin VDD, a ground pin GND and two input pins TI1 and TI2; two output pins LO1 and LO2 successively corresponding to the two input pins TI1 and TI2 can be electrically connected with at least one inductive electric conductor 900, and a maximum of two inductive electric conductors 900; and the human inductive integrated circuit U3 can also be designed to induce the signal when the distance from the human hand to the housing 100 at the paper inlet 110 is not greater than 50 mm;

(2) because the human inductive integrated circuits U3 are different, the connection methods of two inductive electric conductors 900, the triode T3 and two resistors are different, wherein one inductive electric conductor 900 is electrically connected between the input pin TI1 of the human inductive integrated circuit U3 and ground; the resistor R31 corresponding to the inductive electric conductor 900 is electrically connected between the corresponding output pin LO1 of the human inductive integrated circuit U3 and a base b of the triode T3; another inductive electric conductor 900 is electrically connected between the input pin TI2 of the human inductive integrated circuit U3 and ground; the resistor R32 corresponding to the inductive electric conductor 900 is electrically connected between the output pin LO2 of the human inductive integrated circuit U3 and the base b of the triode T3; the power pin VDD of the human inductive integrated circuit U3 is externally connected with a positive power supply VCC; DC voltage of +5V can be adopted as the positive power supply VCC; a collector c of the triode T3 is grounded; an emitter e of the triode T3, as an output end of the human inductive signal processing output module 800, is electrically connected with the control circuit module 300; and

(3) because the human inductive integrated circuits U3 are different, the connection methods of other pins of the human inductive integrated circuits U3 are different, wherein the optional input pin OSC of the human inductive integrated circuit U3 can be externally connected with the positive power supply VCC as required, or grounded; in the present embodiment, the optional input pin OSC is externally connected with the positive power supply VCC; the capacitor C33 is electrically connected between the sampling capacitor access pin VC of the human inductive integrated circuit U3 and the ground pin GND; the capacitor C32 is electrically connected between the power pin VDD of the human inductive integrated circuit U3 and the ground pin GND; and the ground pin GND of the human inductive integrated circuit U3 is grounded.

### Embodiment 5

As shown in FIG. 1 to FIG. 3 and FIG. 8, the paper shredder of the present embodiment is almost the same as that of embodiment 4, and the difference is that:

(1) only one inductive electric conductor 900 is arranged; the inductive electric conductor 900 is installed at the inner wall of the housing 100 near any side of the paper inlet 110; the inductive electric conductor 900 and the inner wall of the housing 100 are in isolating contact or have a slight gap; and the length of the inductive electric conductor 900 is equal to or slightly less than the length of the paper inlet 110; the inductive electric conductor 900 is electrically connected between the input pin TI1 of the human inductive integrated circuit U3 and the ground;

(2) accordingly, only one resistor R31 is arranged; the resistor R31 is electrically connected between the corresponding output pin LO1 of the human inductive integrated circuit U3 and the base b of the triode T3; and

(3) the other input pin TI2 of the human inductive integrated circuit U3 is hung in the air, and the other output pin LO2 of the human inductive integrated circuit U3 is also hung in the air accordingly.

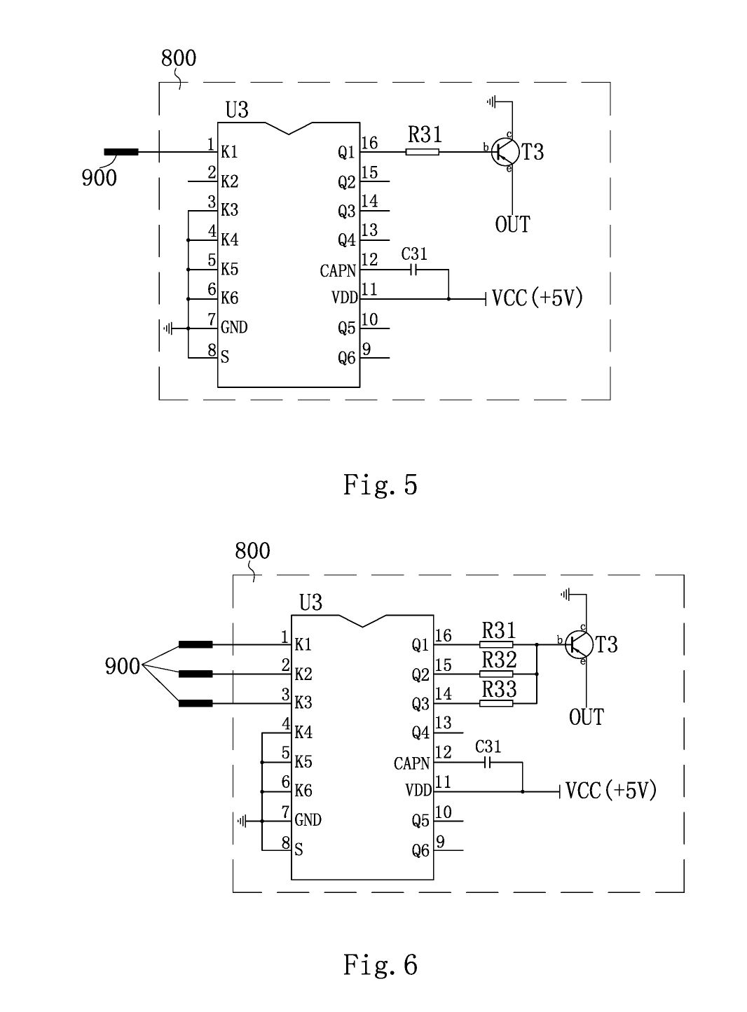

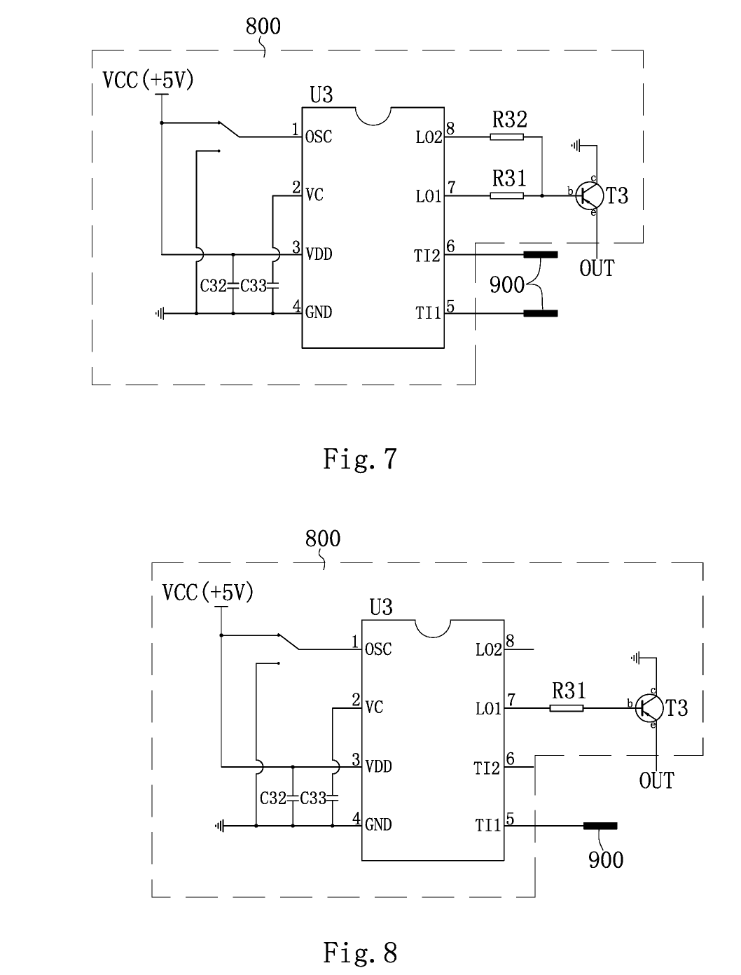

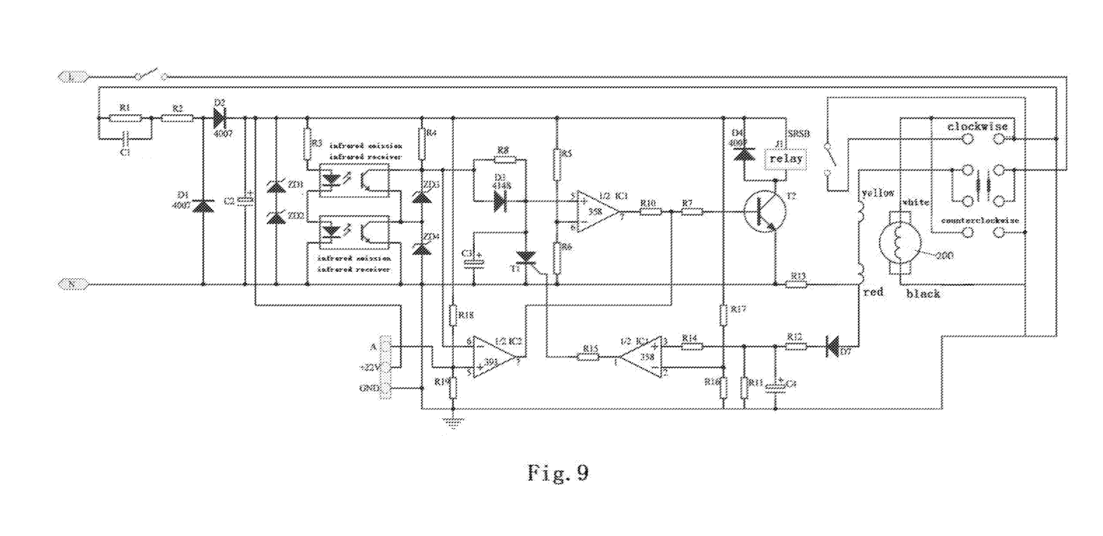

FIG. 9 is a schematic diagram of a specific circuit of the control circuit module 300, and other specific circuits can also be adopted. A terminal A of a binding post in FIG. 9 is electrically connected to the control circuit module 300, that is, electrically connected to the emitter e of the triode T3 in FIG. 4, FIG. 5, FIG. 6, FIG. 7 or FIG. 8. When the paper shredder is in operation, if the human hand approaches or contacts the housing 100 at the paper inlet 110, as long as any inductive electric conductor 900 at the paper inlet 110 of the housing 100 immediately induces the human hand signal, the human hand signal is immediately transmitted to the input pin corresponding to the human inductive integrated circuit U3 of the human inductive signal processing output module 800; the human inductive integrated circuit U3 is triggered to come into operation, and outputs the voltage signal through the resistor R31, the resistor R32 and/or the resistor R33 corresponding to each inductive electric conductor 900 so as to activate the triode T3; the emitter e of the triode T3 outputs the signal to a positive-phase input end pin 5 of an operation amplifier IC2 of the control circuit module 300, and discharges for the positive-phase input end pin 5 of an operation amplifier IC2; when the voltage of the positive-phase input end pin 5 of an operation amplifier IC2 is less than the voltage of a negative-phase input end pin 6 of the operation amplifier IC2, the triode T2 of the control circuit module 300 is broken without electricity; and a relay J1 of the control circuit module 300 is broken, so that the motor 200 is de-energized to stop operating. When the human hand is away from the housing 100 at the paper inlet 110, each inductive electric conductor 900 at the paper inlet 110 of the housing 100 does not induce the human hand signal; the human inductive integrated circuit U3 of the human inductive signal processing output module 800 is not operated; and the control circuit module 300 and the motor 200 maintain previous operating states when the paper shredder is in operation.

The above-mentioned embodiments are specifically described in detail by means of only expressing the preferable executive methods of the present invention, which shall not thereby be understood as limitations to the scope of the said invention patent; it shall be noted by ordinary technicians in the art that several variations and improvements can be made without departing from the conception of the present invention, which are included within the protection scope therein; therefore, any and all equivalent alterations and modifications made within the scope of claims of the present invention are covered by the claims of the present invention.

What is claimed is:

1. A paper shredder, comprising a housing provided with a paper inlet, a motor arranged in the housing, and a control circuit module for controlling the motor to operate; wherein:
further comprising at least one inductive electric conductor and a human inductive signal processing output module, the inductive electric conductor is arranged at the inner wall of the housing near the paper inlet; the inductive electric conductor and the inner wall of the housing are in isolating contact or have a gap; the inductive electric conductor is electrically connected with the human inductive signal processing output module; the human inductive signal processing output module is electrically connected with the control circuit module; the human inductive signal processing output module is triggered to operate after inducing a human hand signal through the inductive electric conductor, and enables the motor to stop operating after outputting the signal to the control circuit module;
when the paper shredder is in operation, when a human hand approaches or contacts the housing at the paper inlet, the inductive electric conductor at the paper inlet of the housing immediately induces the human hand signal and transmits the human hand signal to the human inductive signal processing output module; the human inductive signal processing output module is operated and outputs the signal to the control circuit module; the motor is immediately de-energized to stop operating after the control circuit module receives the signal of the human inductive signal processing output module; when the human hand is away from the housing at the paper inlet, the inductive electric conductor at the paper inlet of the housing does not induce the human hand signal; the human inductive signal processing output module (800) is not operated; and the control circuit module and the motor maintain previous operating states when the paper shredder is in operation.

2. As stated in claim 1, the paper shredder, wherein the inductive electric conductor is a metal foil, iron wire, copper wire or enameled wire.

3. As stated in claim 1, the paper shredder, wherein the number of the inductive electric conductors is two; the inductive electric conductors are respectively arranged at the inner wall of the housing near both sides of the paper inlet; and the length of each inductive electric conductor is equal to or slightly less than the length of the paper inlet.

4. As stated in claim 3, the paper shredder, wherein the human inductive signal processing output module comprises a human inductive integrated circuit, a triode and two resistors; two inductive electric conductors are respectively electrically connected between each input pin of the human inductive integrated circuit and ground; two resistors are respectively electrically connected between each corresponding output pin of the human inductive integrated circuit and a base of the triode; a power pin of the human inductive integrated circuit is externally connected with a positive power supply; a collector of the triode is grounded; an emitter of the triode, as an output end of the human inductive signal processing output module, is electrically connected with the control circuit module; after any input pin of the human inductive integrated circuit, which is connected with the inductive electric conductors, induces the human hand signal through the inductive electric conductors, the human inductive integrated circuit is triggered to operate; a resistor corresponding to the inductive electric conductors outputs a voltage signal to activate the triode; and the motor is made to stop operating after the emitter of the triode outputs the signal to the control circuit module.

5. As stated in claim 3, the paper shredder, wherein the triode is a PNP type triode and has a model of 9012.

6. As stated in claim 1, the paper shredder, wherein the human inductive signal processing output module comprises a human inductive integrated circuit, a triode and the same number of resistors as that of the inductive electric conductors; each inductive electric conductor is respectively electrically connected between each input pin of the human inductive integrated circuit and ground; each corresponding resistor is respectively electrically connected between each corresponding output pin of the human inductive integrated circuit and a base of the triode; a power pin of the human inductive integrated circuit is externally connected with a positive power supply; a collector of the triode is grounded; an emitter of the triode, as an output end of the human inductive signal processing output module, is electrically connected with the control circuit module; after any input pin of the human inductive integrated circuit, which is connected with the inductive electric conductors, induces the human hand signal through the inductive electric conductors, the human inductive integrated circuit is triggered to operate; a resistor corresponding to the inductive electric conductors outputs a voltage signal to activate the triode; and the motor is made to stop operating after the emitter of the triode outputs the signal to the control circuit module.

7. As stated in claim 6, the paper shredder, wherein the triode is a PNP type triode and has a model of 9012.

8. As stated in claim 1, the paper shredder, wherein the gap between the inductive electric conductor and the inner wall of the housing is less than or equal to 5 mm.
